(19) United States
(12) Patent Application Publication
(10) Pub. No.: US 2003/0228516 A1
(43) Pub. Date: Dec. 11, 2003

(54) Comformable battery

(76) Inventor: Patrick P. McDermott, Vienna, VA (US)

Correspondence Address: Patrick P. McDermott, 2411 Rocky Branch Road, Vienna, VA, 22181, US

(21) Appl. No.: 10/456,625

(22) Filed: Jun. 9, 2003

Related U.S. Application Data
(60) Provisional application No. 60/386,167, filed on Jun. 7, 2002.

(51) Int. Cl. H01M 2/24; H01M 2/02

(52) U.S. Cl. 429/160; 429/176; 429/153

(57) ABSTRACT

The Conformable Battery encompasses a class of devices wherein the outer casing of the battery may be configured in a variety of shapes to fit specific applications including flat planar designs (circular, square, rectangular) and three-dimensional geometric shapes (e.g., curved plates, thin cylinders with hollow cores, other geometric shapes). The internal structure of the battery consists of multi-cell compartments where the walls of the compartments are bonded to the outer skin contributing to the batteries' structural stiffness, integrity, and ability to sustain moderate to high internal pressure, with enhanced ability to dissipate heat. The design is applicable to the patented Bimodal Battery concept (U.S. Pat. No. 6,187,471B1) as well as other battery design concepts.

This application claims the priority of U.S. Provisional Application No. 60/386,167, filed Jun. 7, 2002, which is herein incorporated by reference. Elements of the Conformable Battery concept incorporate activation mechanisms described in the Bimodal Battery patent U.S. Pat. No. 6,187,471B1, issued Feb. 13, 2001, as referenced in this application.

### BACKGROUND OF THE INVENTION

1. Field of the Invention

The invention relates to batteries, and particularly batteries that can be manufactured in a variety of shapes and geometries that better utilize available space in specific electronic and aerospace applications.

2. Description of the Prior Art

Most high power, high energy density batteries used in the aerospace, defense, and electric vehicle applications industry today consist of cylindrical or rectilinear, prismatic-shaped cells used singly, or connected in parallel or series into battery packs, depending on the voltage and current requirements of the mission. These batteries are classified as either primary or secondary depending on the intended use and design of the battery. In a primary battery, the stored energy is released in an irreversible process, and the battery is depleted when the total energy capacity of the cell is released. A secondary battery is one where the stored energy is released in a reversible process, and the battery is capable of being repeatedly charged and discharged.

Examples of secondary batteries include lead acid, nickel cadmium and nickel metal hydride batteries, which have found widespread use in the commercial market place as rechargeable electrical power sources for use in tools, starting motors, flash lights, electric vehicles, and a variety of other uses. Aerospace qualified nickel cadmium and nickel hydrogen batteries are used in space and satellite applications to provide renewable sources of electrical energy, recharged with solar panels extended from the satellite structure. Secondary lithium ion batteries are now being introduced as high energy density power sources for both space and electric vehicle applications.

In most of the above examples, the battery consists of multiple cylindrical or prismatic cells built up by connecting these cells into cell packs, usually a rectilinear package similar in form to a standard automobile battery. In the case of certain Nickel Hydrogen batteries, called common vessel batteries, in addition to the electrical connection between cells, there is also a network of tubing that allows pressurized hydrogen to flow from cell to cell. Primary batteries also utilize cylindrical and prismatic cells connected in series or parallel, depending on the voltage and current needs of the application.

A reserve battery is a primary battery that can be stored for long periods of time prior to discharge, and that requires some form of activation to bring it to a full operational state. The reserve battery is inhibited from open circuit self-discharge during the pre-activation state by having the electrolyte stored separately from the electrodes or by having the electrolyte infused into the plate stack of the battery in a non-conductive state.

Aerospace and defense applications usually employ a so-called “thermal” battery as the reserve battery. For the thermal battery, the electrolyte permeates the plate stack as a solid-state salt and is non-conductive for the range of storage temperatures in the pre-activation state. The thermal battery is activated by the ignition of an internal pyrotechnic that heats the electrolytic salt to a liquid state, wherein the electrolyte is capable of conducting current, thus activating the battery.

In other reserve battery designs, the plate stack is dry, and the electrolyte is stored in liquid form in a separate storage reservoir. Upon activation, the electrolyte is injected into the plate stack allowing the battery to discharge current into the load attached to the terminals of the battery. In the lithium thionyl chloride reserve battery, for example, an acidic form of the thionyl chloride electrolyte is contained in the separate reservoir and injected into the plate stack to achieve activation.

The Bimodal Battery (U.S. Pat. No. 6,187,471B1) is an alternative design of the reserve lithium battery, which allows it to function as a low-drain battery during periods of storage, and then, after activation, to function as a very high current battery to meet high power density missions. In the Bimodal Battery, the plate stack is infused with non-acidic, neutral thionyl chloride based electrolyte, which allows it to function as a low-current drain power source. Activation is achieved by injecting and mixing an acid additive that creates an acidic form of the electrolyte in the plate stack. The acid electrolyte allows the battery to function as a very high current power source for a relatively short period of time.

Both the thermal and thionyl-chloride reserve batteries are used in aerospace and defense application to power missile and launch vehicle electronics, ignition of pyrotechnics for staging and separation, power for electric actuators for moving fins and control surfaces, and power for passive and active on-board sensors. These applications required heavy current for a limited duration.

Secondary batteries are used, once a satellite has been launched into space, to continuously power the electronics, the telecommunication data links, and sensors. These batteries can be recycled in space for multiyear missions using large solar arrays to recharge the batteries.

Many of the high energy density, high power density batteries used for aerospace and defense create high levels of thermal energy and internal pressure during their operation. These effects are taken into account when designing batteries such as, thermal management techniques to remove heat from the core of the battery, and special pressure containment vessels and relief valves to manage internal pressure buildup. As a result of these thermal and pressure requirements, system designers are often constrained by the form and fit factors of the batteries designed for aerospace applications.

Thin, flat-plate and conformable batteries have been developed in the commercial electronics industry to maximize packaging density, allowing system designers to add the battery efficiently to the electronics system without having to design the electronics package around the shape of the battery. Cell phones for example have snap-on batteries with relatively thin rectangular shapes. Thin-line button cells are used in watches to conform to the shape of the watch. But, these batteries are not required to deliver the high currents required in the aerospace applications cited above. What is needed in the defense and aerospace industry are battery concepts that gives the aerospace engineer or missile designer the same design flexibility, to fit the battery efficiently into the electronics environment without having to distort that environment.

This is the intent of the Conformable Battery concept, to bring the design flexibility already exploited in low-drain batteries for commercial electronics, to the high energy and power density battery world of missiles and aerospace electronics. Electronics are usually laid out on printed wire circuit boards (PWBs) or cards, which are planar, rectangular-shaped plates, sometimes stacked in parallel into electronics boxes to conserve space. Why not build the battery in the same shape, to slide into the electronics box enclosure along with the printed circuit cards? Missile bodies are cylindrical in shape with electronics on disks that are stacked in parallel in a cylindrical electronics box. Why not build a thin, circular-shaped batteries to conform to the electronics package? Or, build a thin-walled battery in a curved shape that fits around the electronics and conforms to the outer shape of the missile.

Space satellites are sometimes built in modular fashion as rectangular or cylindrical boxes with components and subsystems stacked on shelves within the enclosure. Why not design the battery powering the satellite as a flat plate that can act as one or more of the shelves? In this concept, the battery would be acting as a multifunctional element of the system. It would serve as a power source, but also as a structural member of the satellite structure.

In the Conformable Battery concept, the battery casing is formed by sandwiching a grid of short vertical walls between top and bottom plates, thus forming individual cell compartments, mechanically and electrically isolated from each other. The walls of these compartments act as stiffeners between the two outer casing plates providing substantial mechanical strength and stiffness, similar to light-weight aluminum or composite aerospace structures made from honeycomb structures sandwiched between two face sheets. The multi-cell compartments can serve as enclosures for individual cell stacks which can then be linked together electrically with series or parallel connections.

Depending on how the individual compartments are shaped, the architecture of the Conformable Battery allows for distribution of individual cell stacks across different geometries including: rectangular or cylindrical flat plate batteries, curved plate batteries, cylindrical batteries with an open core, or other three dimensional shapes that conform to the geometric requirements of specific applications.

In addition to added flexibility in shaping the battery to fit or conform to the dimensional requirements of the application, the thinned plate geometries have the added value of increasing the surface area of the external packaging. This facilitates better transfer of heat from the plate stacks to the external environment. This is a critical need for high rate of discharge batteries, where heat of the electrochemical reactions occurring during discharge can be trapped in the core of cylindrical or prismatic geometries, increasing internal pressures and degrading performance.

The internal structure of stiffeners also contributes to the ability of the casing to contain substantial internal gas pressures that can be generated during charge/discharge cycles, especially in the case of nickel-hydrogen batteries, by distributing and channeling the mechanical load on the large area face plates through the grid of vertical compartment walls.

The Conformable Battery concept and architecture is applicable to a number of secondary and primary battery chemistries. In the case of secondary batteries, this would include, but not limited to, lead acid, nickel cadmium and nickel metal hydride batteries, which have found widespread use in the commercial market place as rechargeable electrical power sources, and aerospace qualified nickel cadmium and nickel hydrogen batteries used in space and satellite applications, and secondary lithium ion and batteries for use in space applications, as well as, terrestrial electric vehicle applications.

The Conformable Battery concept and architecture is also applicable to the field of primary batteries including, but not limit to, common alkaline primaries, lithium ion, and low-drain lithium oxyhalide (e.g., lithium thionyl chloride). As regards the conventional primary reserve batteries, the Conformable Battery concept, although feasible, might be impractical for certain classes of the primary reserve batteries, for example, the high temperature reserve thermal batteries (too much heat radiated away from the battery during operation), or the reserve lithium thionyl chloride battery with the separate acid electrolyte reservoir (difficult to maintain a vacuum in the multi-cell flat plate architecture, then pump large quantities of electrolyte throughout the individual cell compartments). In conventional lithium reserve batteries, the electrolyte must be forcibly injected into the plate stack under relatively high pressure in order to assure rapid contact of the electrolyte with the dry plate stack.

Limitations associated with the Conformable Battery architecture for primary reserve batteries, however, do not extend to the Bimodal Battery concept. In fact, the Bimodal Battery is an excellent candidate for use as a Conformable Battery. In the case of the Bimodal Battery, where most of the neutral electrolyte is already stored in the multiple cells, only the acid additive need be injected into the cells during activation, and the activation process can be carried out under moderately low pressures. This low pressure, moderate temperature environment is why the Bimodal Battery is an excellent candidate for implementing the Conformable Battery concept, as opposed to the conventional thermal or lithium thionyl chloride reserve battery with separate reservoir.

The Bimodal Battery is potentially 30-40% smaller in size than conventional primary reserve lithium batteries since the acid component held in reserve prior to activation is much smaller, volumetrically, than the total electrolyte held in reserve in the conventional lithium reserve battery. The bimodal battery is also potentially lighter in weight, since the mechanisms required to pump and mix the additive are smaller and operate at a much lower pressure. This more benign, lower pressure, activation reduces the need for high pressure, heavy containment vessels, and could also provide more margin of safety since the activation less stressful. In the Bimodal Battery, the lower pressure of activation allows some flexibility in the types of geometries that can be accommodated.

In order to improve the manufacturability of the Conformable Battery, much of the wiring to connect the multiple cells, as well as the fluidic paths required to move electrolyte additives into the multiple cells, can be embedded in the top and bottom plates enclosing the battery casing.

### SUMMARY OF THE INVENTION

It is an object of the invention to provide a battery architecture wherein the outer casing of the battery may be configured in a variety of shapes to fit specific applications including flat planar designs (circular, square, rectangular) and three-dimensional geometric shapes (e.g., curved plates, thin cylinders with hollow cores, other geometric shapes).

It is a further object of the invention to provide an internal structure to the battery forming of multi-cell compartments where the walls of the compartments are bonded to the outer skin contributing to the batteries' structural stiffness, integrity, and ability to sustain moderate to high internal pressure.

It is an object of the invention to provide a battery that can be configured in different external shapes, by selective arrangement of individual plate stacks in separate, electrically isolated compartments, contiguous to each other, depending on the desired geometry, with each compartment containing an isolated electrochemically active plate stacks.

It is an object of the invention to provide a battery that can provide higher voltages through series connection of multiple plate stacks, and/or multiple voltages through voltage taps at various locations throughout the multi-cell, plate stack compartments.

It is an object of the invention to provide a battery where plate stack compartments are distributed over flat rectangular or circular shaped flat plates or curved plates or other three dimensional shapes depending on the requirement of the application, creating a large surface area in the external casing in order to enhance heat dissipation.

It is an object of the invention to provide an architecture for the reserve lithium Bimodal Battery with the attributes of the Conformable Battery, including a relatively large external surface area to facilitate heat transfer from the core of the battery to the external environment, a multi-cell architecture to allow for higher voltages through series connections, as well as, the ability to provide for multiple voltage taps.

It is an object of the invention, in the case of the Bimodal Battery, to provide a manifold system with tubing or channels to distribute the acid additive from a central dispensing reservoir to each of the plate stack compartments in a multi-compartment battery.

It is an object of the invention, in the case of the Bimodal Battery, to provide a return manifold system, when needed, to move excess electrolyte into an electrolyte collection reservoir when needed, as the acid additive is pumped into each compartment of the multi-compartment battery.

It is an object of the invention, in the case of the Bimodal Battery, to provide an alternate means of handling excess electrolyte in each of the multi-cell compartments by creating “dimpels” in the outer casing at each compartment (concave curvature) which are then popped out to a planar or convex curvature when the acid additive, under pressure, is added to each compartment, increasing the liquid volume in each compartment. This eliminates the need for a separate return manifold system for the Bimodal Battery.

It is an object of this invention to provide alternative means of inter cell, inter compartment electrical connections by means of multifunctional structures integral to the outer casing planar or curved planar walls through integral multi-layer planar electrical grids and alternating insulating layers with interlayer connecting vias, similar to the conventional Printed Wire Board (PWB) technology or multi-layer, co-fired ceramic multi-chip module (MCM) technology used in the electronics industry.

It is an object of this invention to provide alternative means of inter cell, inter compartment fluidic connection in order to move electrolyte and additives, or gaseous products, in and out of the compartments, by means of multifunctional structures integral to the outer casing planar or curved planar walls through platelet technology developed for use in the aerospace industry. This technology is used to move gases or liquids through thin metal structures by superimposing multi-layer diffusion bonded or braised sheets of material with channels and vials cut out of each layer that, when superimposed, provide a network of continuous channels throughout the thin plate.

### BRIEF DESCRIPTION OF THE DRAWINGS

Embodiments of the invention are explained in greater detail by way of the drawings, where the same reference numerals refer to the same features.

FIG. 1(a) illustrates a prospective view of the outer casing of a nine-compartment rectangular-shaped Conformable Battery.

FIG. 1(b) illustrates a prospective view of the outer casing of an eight compartment circular-shaped Conformable Battery.

FIG. 1(c) illustrates a prospective view of the outer casing of an eighteen compartment Conformable Battery in the form of a truncated cylinder with open core.

FIG. 1(d) illustrates an exploded view of a nine compartment, rectangular-shaped battery showing grid of compartment walls with top and bottom outer casing plates.

FIG. 1(e) illustrates an exploded view of the circular battery showing grid of pie-shaped compartment walls with top and bottom outer casing plates.

FIG. 2 illustrates a top view of the Bimodal Battery form of the circular battery with electrolyte additive injected into pie shaped compartments from central well.

FIG. 3 illustrates a top view of the Bimodal Battery form of the rectangular battery with electrolyte additive injected into compartments from side well.

FIG. 4 illustrates a prospective view of a layered multifunctional plate structure providing a series electrical connection grid for the Bimodal Battery in FIG. 1(a).

FIG. 5 illustrates a prospective view of a layered multifunctional plate structure providing fluidic channels to the nine-compartment Bimodal Battery in FIG. 3.

FIG. 6(a) is a side view one compartment of Bimodal Battery with “dimpled” concave top.

FIG. 6(b) is a side view of one compartment with convex top after introduction of acid additive under pressure.

### DESCRIPTION OF THE PREFERRED EMBODIMENTS

FIG. 1 shows the basic structure of the Conformable Battery architecture including as examples: a the thin-walled, flat-plate rectangular battery shown in FIG. 1(a) with outer casing 1; a thin-walled, flat-plate circular battery in FIG. 1(b) with outer casing 2; a curved-shape, truncated cylindrical Conformable Battery in FIG. 1(c) with outer casing 3. The designs illustrate the advantages of the Conformable Battery approach where variable geometries can be produced that better meet requirements of specific applications from a form, fit, and function point of view. The larger surface area of the flat plate or conformal batteries also aids thermal management by providing a larger surface for heat dissipation.

The flat plate or conformal configuration facilitates compartmentalization of individual plate stacks for multi-cell architectures, allowing multiple voltage taps, or higher voltage operation with series connection of multiple cells. The dotted lines 4 in FIGS. 1(a)-1(c) illustrate how these flat-plate/conformal designs can be compartmentalized, with compartment walls bonded to the outer skin of the battery contributing to structural stiffness and integrity. Each compartment in subsequent Figures will be shown to contain the electrochemically active plate stacks (positive and negative electrodes, with separators, immersed in electrolyte).

FIG. 1(a) is an exploded view of FIG. 1(a) showing a grid of vertical walls 5, sandwiched between and upper plate 6 and a lower plate 7.

FIG. 1(e) is an exploded view of FIG. 1(b) showing a grid of vertical walls 8, sandwiched between and upper plate 9 and a lower plate 10.

FIGS. 2 and 3 show different mechanisms for distributing electrolyte in the flat-plate or conformal designs. FIG. 2 is a circular thin plate battery similar to FIG. 1(b) where the acid additive is dispensed from a central well 11 into pie-shaped plate stack compartments 12 through multiple valves 13 that inhibit “soft shorts” (ionic species from one cell migrating to other cells that may be at higher voltage levels in a series connected battery).

FIG. 3 shows a rectangular plate design, similar to the battery in FIG. 1 with, however, the addition of an acid reservoir 14 dispensing the acid additive 15 through a network of tubes 16 into the multiple plate stack compartments 17.

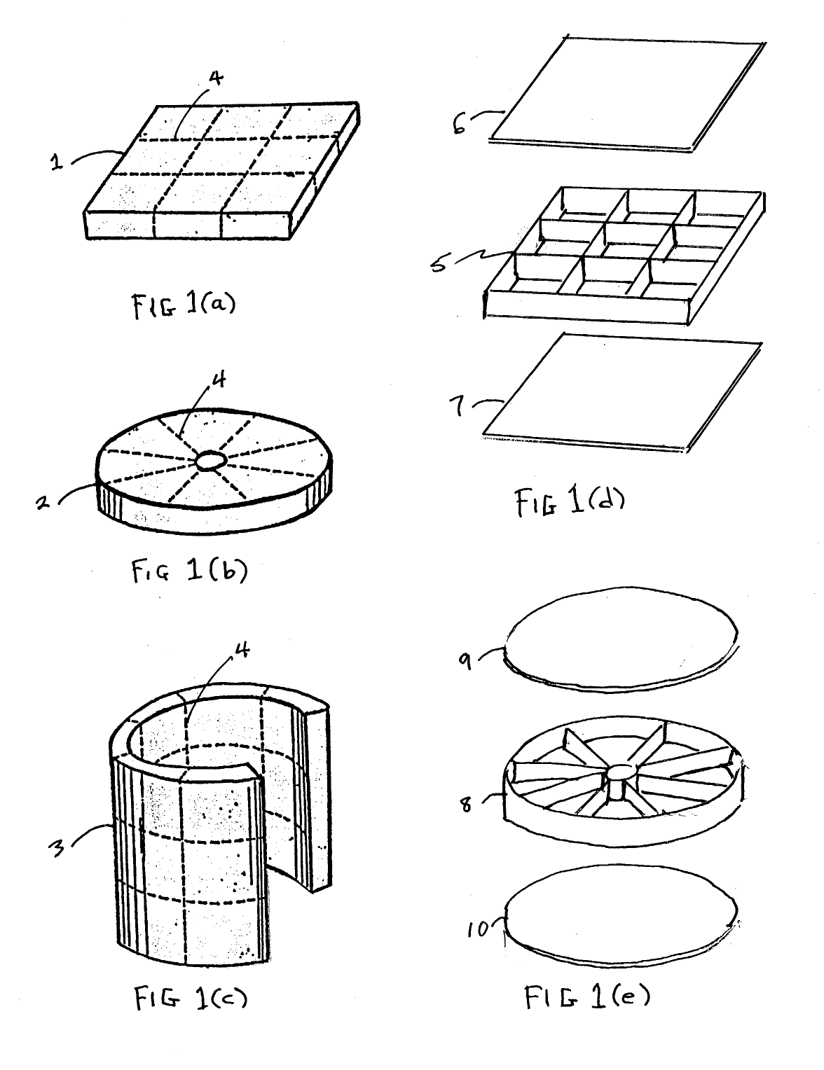

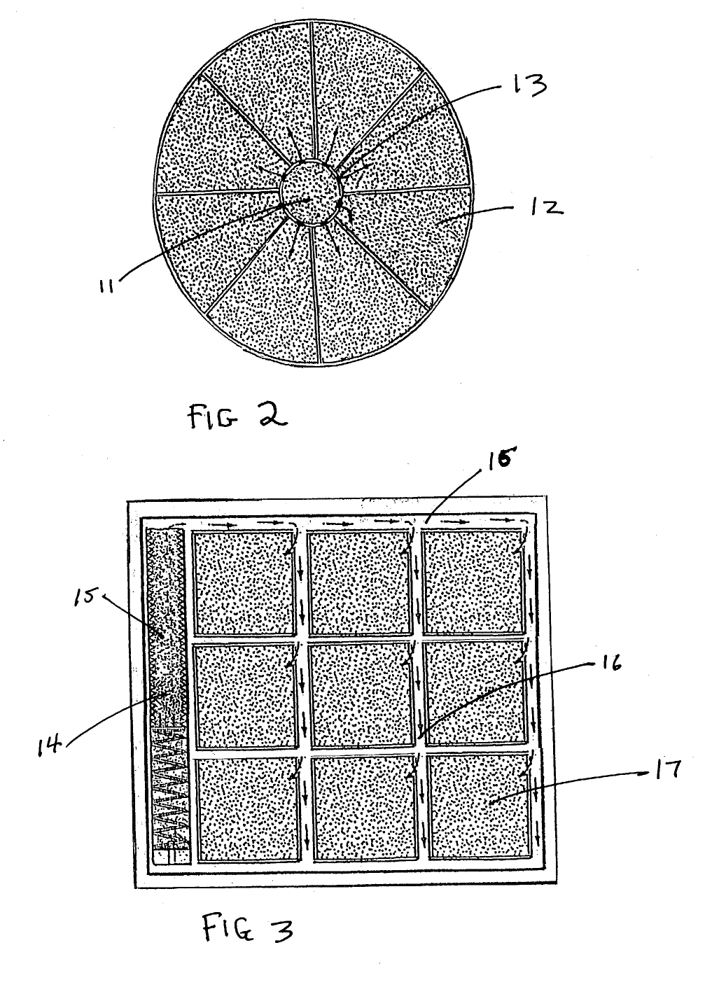

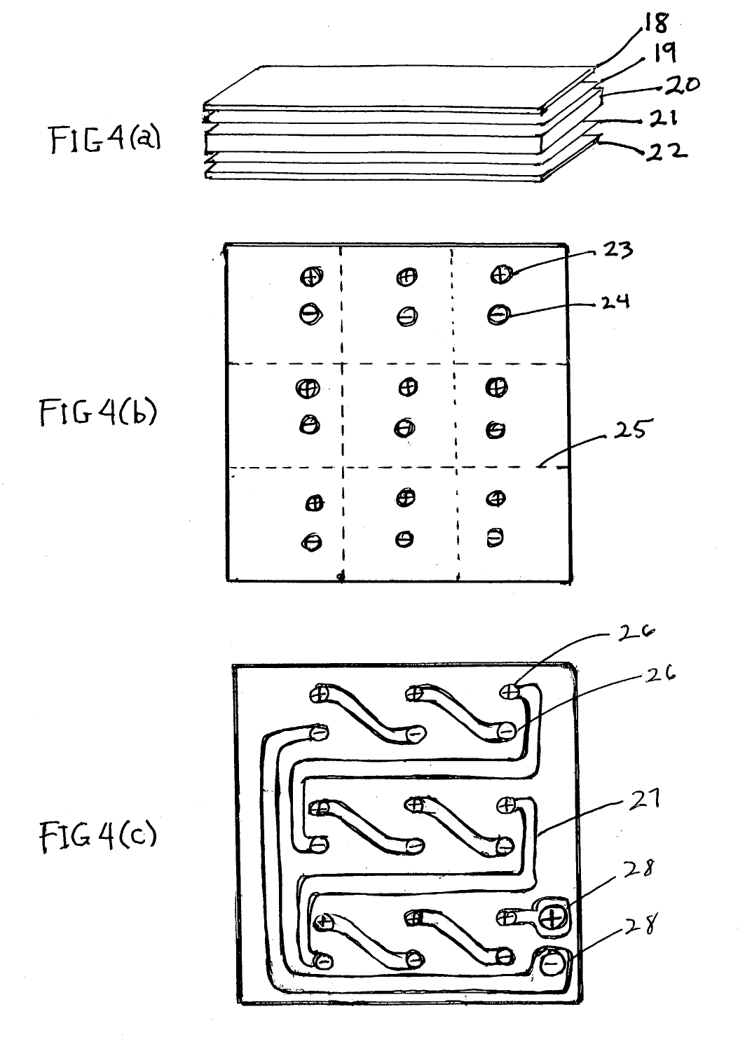

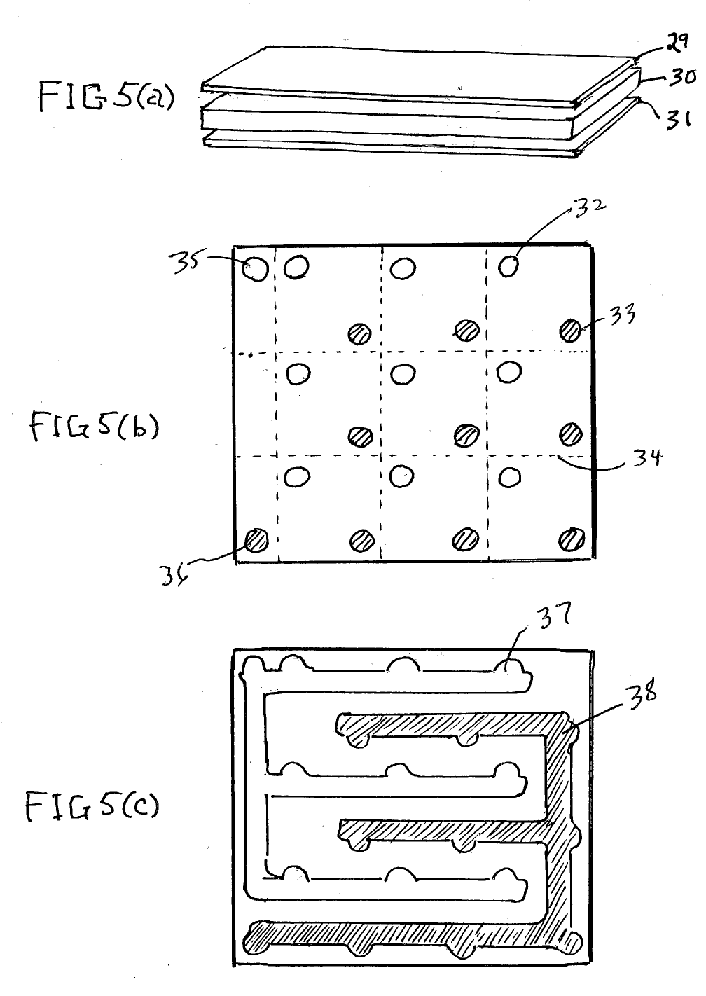

FIG. 4 illustrates an alternative means of electrically interconnecting the compartment cells with series or parallel connections, with a thin multi-layered, multifunctional plate structure, which acts as the outer casing wall, similar to item 7 in FIG. 1(d), but also provides, though a network of conductors, the electrical interconnects to the plate stacks.

FIG. 4(a) is an exploded, perspective view of a 5-layer system: layer 1, the top layer 18 faces the interior of the battery; layer 2 is an insulating layer 19 between 18 and 20 made of kapton or other insulating material which may be required if plates 18 and 20 are metallic or otherwise conductive; a mid layer 20 contains the conductive grid linking the plate stacks electrically; layer 4 provides another insulating layer 21 between 20 and 22; and, finally, layer 5, the bottom layer 22 is a solid plate which forms the outer skin of the battery casing.

FIG. 4(b) is a top view of 18 showing holes or vias 23 and 24 where the positive and negative leads from the plate stacks in the individual compartments can be soldered to the tabs in the middle layer 20, where inter compartmental connections can be made. The dotted lines 25 in FIG. 4(b) correspond to the footprint where the vertical grid walls 5 are connected to 18. The insulating layer 19 has the same footprint of holes as shown in layer 18 FIG. 4(b).

FIG. 4(c) is a top view of the middle layer 20 contains a network of copper ribbon strips or other ribbon conductors that form positive and negative tabs 26 with conductive paths 27 between the tabs. The copper or other ribbon conductors are on a nonconductive media. This network or grid of conductors is designed to implement a series connection of the nine plate stack, so that the voltages are additive. Alternate grids of course could be formed to provide any series or parallel connections among the plate stacks. The large tabs at the bottom 28 provide the leads for charging and discharging the battery.

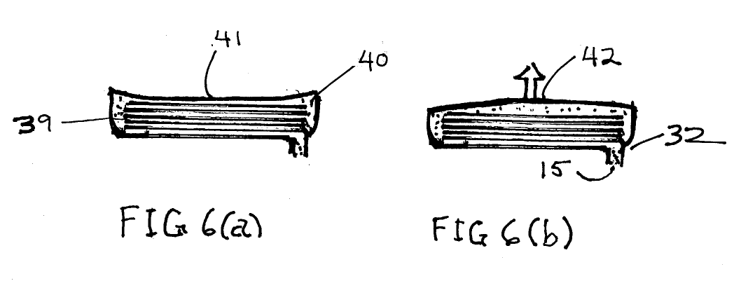

FIG. 5 illustrates an alternative means of inter cell, inter compartment fluidic connection in order to move electrolyte and additives, in and out of the compartments, by means of multifunctional structures integral to the outer casing planar or curved planar walls through platelet technology developed for use in the aerospace industry. This technology is used to move gases or liquids through thin metal structures by superimposing multi-layer diffusion bonded or braised sheets of material with channels and vials cut out of each layer that, when superimposed, provide a network of continuous channels throughout the thin plate.

FIG. 5(a) is an exploded, perspective view of 3-layer system: layer 1, the top layer 29 faces the interior of the battery; layer 2, a mid layer 30 contains channels cut into the plate providing channels for the movement of the electrolyte; layer 3, the bottom layer 31 is a solid plate which forms the outer skin of the battery casing.

FIG. 5(b) is a top view showing holes or vias 31 and 32 to the manifolds in layer 30 where the input port is shown as an open circle 31, and the return port is shown as a shaded circle 32. The dotted lines 34 in FIG. 5(b) correspond to the footprint where the vertical grid walls are connected to 29 with a footprint similar to that shown in FIG. 3. The spring loaded piston activation mechanism 14 on the left hand side of FIG. 3 would pump additive 15 into the channel grid in layer 30 through port 35 and retrieve excess electrolyte through port 36.

FIG. 5(c) is a top view of the middle layer 30 containing channels corresponding to the manifold 37 for distributing additive 14 into the nine compartments of the battery, and a return manifold 38 for retrieving excess electrolyte from each of the nine plate stack chambers and returning it behind the activation piston, through port 36.

FIG. 6 illustrates a means of handling excess electrolyte in each of the multi-cell compartments by creating “dimpels” in the outer casing at each compartment (concave curvature), which are then popped out to a planar or convex curvature when the acid additive, under pressure, is added to each compartment, increasing the liquid volume in each compartment.

FIG. 6(b) is a side view of one compartment containing the cell stack 39 filled with neutral electrolyte 40 where the top 41 is concave. FIG. 6(b) is a side view of the same compartment after additive 15 is injected under pressure through port 32 causing expansion of the chamber with the top 42 assuming a convex shape. This grid of channel shown in FIG. 6(b) eliminates the need for a separate return manifold system for the Bimodal Battery shown as 38 in FIG. 5.

What is claimed is:

1. A Conformable Battery comprising:
an outer casing having at least one wall;
an internal structure consisting of a grid of walls attached to and substantially normal to said outer casing walls dividing an internal volume of said battery into compartments;
an electrochemically active plate stack consisting of positive and negative electrodes with separators and insulators located within each of said compartments;
an electrolyte located within the said outer casing and said compartments;
a network of electrical conductors providing electrical connection of said plate stacks within said compartments.

2. A battery according to claim 1, wherein the said external casing is conformable to various shapes with arrangement of said compartments in a manner compatible with an external shape of said battery, said external shape comprising one of the group;
a substantially rectilinear battery formed by attachment of substantially rectangular faceplates affixed to said grid of compartment walls normal to the faceplates;
a substantially circular battery formed by attachment of circular faceplates affixed to said grid of compartment walls normal to the faceplates;
a curved battery consisting of said compartment walls formed by attachment of archal faceplates attached to convex and concave faceplates;

3. A battery according to claim 1, consisting of multiple cell compartments, each of said compartments isolated mechanically and electrically from each other of said compartments, including the movement of ionic species in the electrolyte from one of said compartments to another of said compartments.

4. A battery according to claim 1, wherein said plate stacks in said compartments are capable of being connected electrically through one method of the group of: series, parallel, and combination of series and parallel each one of said series, parallel and combination of series and parallel providing an operational voltage and current adapted to a specific application.

5. A battery according to claim 1, consisting of said multiple cell compartments, wherein said compartments are mechanically connected to each other of said compartments such that electrolyte and other additives can flow from one of said compartments to another of said compartments and be injected into each of said compartments from a common reservoir.

6. A battery according to claim 1, wherein the walls of said compartments act as stiffeners between the two outer casing plates providing substantial mechanical strength and stiffness to the outer casing structure.

7. A battery according to claim 1, wherein said walls of said compartments act as stiffeners between said outer casing walls, in combination with said outer casing plates, providing an enclosed space capable of containing substantial internal pressure.

8. A battery according to claim 1, wherein said plate stack within each of said compartments, create a large surface area of said external casing relative to the volume of the battery, enhancing heat dissipation from an interior of the battery to external environment.

9. A battery according to claim 1, which provides elements to support the operation of a reserve lithium battery, particularly the Bimodal Battery, including:
a relatively large external surface area to facilitate heat transfer from the core of the battery to the external environment;
a multi-cell architecture allowing series, parallel inner-cell connections, as well as, the ability to provide for multiple voltage taps;
a manifold system with channels to distribute an acid additive from a central dispensing reservoir to each of said plate stack compartments in a multi-compartment battery;
a manifold system to move excess electrolyte into an electrolyte collection reservoir as said acid additive is pumped into each of said compartments of the multi-compartment battery.

10. A battery according to claim 9, containment means for containing excess electrolyte in said Bimodal Battery without recourse to said return manifold and collection system comprising:
dimples in said outer casing of each of said compartments, each dimple forming concave curvature;
said dimples in said outer casing capable of expanding to a planar or convex curvature when said acid additive, under pressure, is added to each of the said compartments, increasing the liquid volume in each of the said compartments.

11. A battery according to claim 1, providing alternative means of inter-cell, inter-compartment electrical connections by means of multifunctional structures integral to said outer casing walls by means of an integral multi-layer system comprising:
a top layer facing the interior of said battery with a footprint of vias for connecting plate shack to mid-layer electrical grid;
an insulating layer;
a mid layer containing said conductive grid linking said plate stacks electrically;
an insulating layer;
a solid plate forming an outer skin of the said battery casing.

12. A battery according to claim 9, providing inter- cell, inter-compartment fluidic connection means for moving said electrolyte and additives, in and out of said compartments, or gaseous products in and out of said compartments, by means of a multifunctional multi-layered outer casing structure comprising:
a top layer facing the interior of said battery with a footprint of vias for connecting said compartments to a mid-layer network of channels;
a mid layer network of channels interconnecting said compartments with means of injecting and retrieving said electrolytes and additives, or gaseous products;
a solid plate forming the outer skin of the said battery casing
